(19) United States
(12) Patent Application Publication
(10) Pub. No.: US 2018/0140898 A1
(43) Pub. Date: May 24, 2018

(54) Golf Club Training Apparatus

(71) Applicant: John Robert Kasha, North Potomac, MD (US)

(72) Inventor: John Robert Kasha, North Potomac, MD (US)

(21) Appl. No.: 15/576,259

(22) PCT Filed: May 23, 2016
(86) PCT No.: PCT/US16/33797

§ 371 Date: Nov. 21, 2017

Related U.S. Application Data
(60) Provisional application No. 62/166,031, filed on May 25, 2015.
(60) Provisional application No. 62/186,020, filed on Jun. 29, 2015.
(60) Provisional application No. 62/217,225, filed on Sep. 11, 2015.
(60) Provisional application No. 62/304,269, filed on Mar. 6, 2016.

(51) Int. Cl. A63B 24/00; A63B 69/36; A63B 71/06; H04M 1/725

(52) U.S. Cl. CPC A63B 24/0003; A63B 69/3632; A63B 71/0622; H04M 1/72522; A63B 2220/13; H04M 1/72569; A63B 2220/802; A63B 2220/807; A63B 2220/833; A63B 2225/01; A63B 2225/50; A63B 2220/44

(57) ABSTRACT

An apparatus for viewing the position of a golf club head face relative to a golf ball includes one or more sensors and a wireless transceiver. The one or more sensors detect the position of the golf club head relative to the golf ball at a plurality of locations. The one or more sensors also detect the yaw, pitch, or roll of the golf club head. The wireless transceiver transmits the detected information to an external wireless device to provide visual feedback on the position of the golf club head. The apparatus further corrects the position of golf club head face by including one or more aerodynamic control surfaces and a microcontroller. The microcontroller calculates a corrected path from the detected information and controls the one or more aerodynamic control surfaces to correct the position of golf club head before the golf club head strikes the golf ball.

### CROSS REFERENCE TO RELATED APPLICATION

This application claims the benefit of U.S. Provisional Patent Application Ser. No. 62/166,031, filed May 25, 2015, U.S. Provisional Patent Application Ser. No. 62/186,020, filed Jun. 29, 2015, U.S. Provisional Patent Application Ser. No. 62/217,225, filed Sep. 11, 2015, and U.S. Provisional Patent Application Ser. No. 62/304,269, filed Mar. 6, 2016, the contents of all of which are incorporated by reference herein in their entireties.

### INTRODUCTION

The teachings herein relate to a golf training apparatus to determine the path and orientation of a golf club head with respect to a golf ball just before the golf club head strikes the ball. More particularly the teachings herein relate to systems and methods for detecting the location and orientation of a golf club head with respect to a golf ball and communicating the location and orientation wirelessly to a mobile display device and/or correcting the location and orientation using a flight control surface.

### BACKGROUND

For the average golfer, hitting a golf ball from a tee with the driver is one of the most difficult shots. For a right-handed player, the ball often either goes to the right (a slice) or to the left (a hook). It is very difficult to hit the ball with driver down the center of a fairway. One reason this is a difficult shot is because most golfers cannot consistently “square” the club face of the driver at impact with the golf ball. In other words, at the moment most golfers strike the ball, the plane of the club face of the driver is not perpendicular to the direction in which the golfer would like the ball to go. In addition, the ball may be sliced or hooked if the path of the driver at impact is not parallel to the direction in which the golfer would like the ball to go. As a result, in order to hit a golf ball in the desired direction, at impact, the club face of the driver must be perpendicular to the desired direction and, at impact, the path of the driver must be parallel to the desired direction. Both conditions must hold.

The last few feet of the downswing are, therefore, the most critical part of a golf swing. As a result, there is a need for a training apparatus that a golfer can use to, at least, view the last few feet of the downswing and see how the golf club head face is oriented with respect to the golf ball. A golfer can use this immediate feedback on to improve his or her swing. Once this type of data is available on the path and orientation of the golf club face, there is a need for systems and methods to correct the path and orientation of the golf club head face path and provide feedback to the golfer to improve his or her swing.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a series of diagrams showing how various configurations of the direction of a club head face and a club head path at impact affect the flight path of a golf ball.

FIG. 2 is an exemplary diagram of a golf swing training apparatus for viewing the location and orientation of a golf club head face relative to a golf ball before the golf club head face strikes the golf ball during the downswing of a golf club swing, in accordance with various embodiments.

FIG. 3 is an exemplary diagram of the golf swing training apparatus of FIG. 2 further including a microcontroller and one or more aerodynamic control surfaces, in accordance with various embodiments.

FIG. 4 is an exemplary diagram of a golf swing training apparatus for viewing the location and orientation of a golf club head face relative to a golf ball before the golf club head face strikes the golf ball during the downswing of a golf club swing that includes a removable golf club head attachment device, in accordance with various embodiments.

FIG. 5 is an exemplary diagram of a head of a golf club being three dimensionally (3D) scanned by a 3D scanner, in accordance with various embodiments.

FIG. 6 is an exemplary diagram of a removable golf club head attachment device being printed by a 3D printer, in accordance with various embodiments.

FIG. 7 is an exemplary diagram showing a golf ball locating mat that includes one or more mat sensors that transmit signals from one or more locations from the golf ball locating mat, in accordance with various embodiments.

FIG. 8 is a side view of the golf ball locating mat of FIG. 7, in accordance with various embodiments.

FIG. 9 is an exemplary diagram showing a passive golf ball locating mat that includes one or more orientation surfaces that are detected by one or more sensors of the golf swing training apparatus to determine a position and orientation of the golf ball locating mat, in accordance with various embodiments.

FIG. 10 is a side view of the passive golf ball locating mat of FIG. 9, in accordance with various embodiments.

FIG. 11 is an exemplary diagram of a golf swing training apparatus for correcting the location and orientation of a golf club head face relative to a golf ball before the golf club head face strikes the golf ball during the downswing of a golf club swing, in accordance with various embodiments.

FIG. 12 is an exemplary diagram of a golf swing training apparatus for correcting the location and orientation of a golf club head face relative to a golf ball before the golf club head face strikes the golf ball during the downswing of a golf club swing where correction calculations are performed on an external wireless device, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Club Face Viewing and/or Squaring Device

As described above, most golfers cannot consistently “square” the club face of a golf club at impact with the golf ball or make the path of the club head of the golf club at impact parallel to the direction (target direction) in which the golfer would like the ball to go. This is particularly true of the driver.

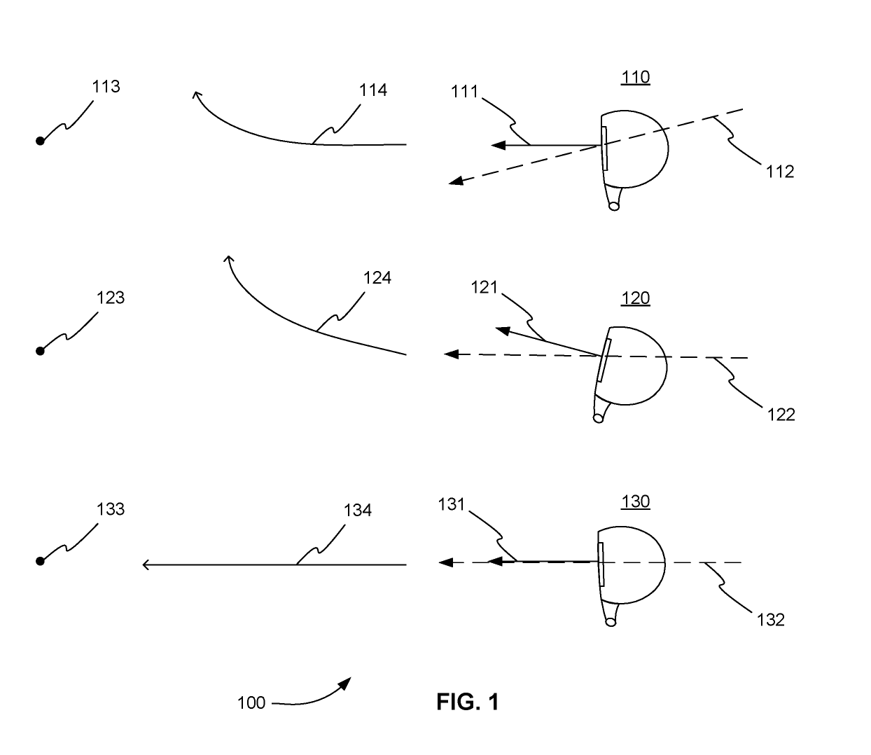

FIG. 1 is a series 100 of diagrams showing how various configurations of the direction of a club head face and a club head path at impact affect the flight path of a golf ball. Diagram 110 depicts the club head conditions for a straight slice golf shot. Club head face perpendicular line 111 (the direction of the club head face) is parallel to the direction to target 113. Target 113 is, for example, a location a golfer selects as the intended location for the golf ball after the golf shot is executed. However, club head path 112 is not parallel to the direction to target 113. The club head face starts the ball off in the right direction, but the lack of alignment between club head face perpendicular line 111 and club head path 112 imparts a spin on the golf ball. As golf ball path 114 shows, this causes the golf ball to eventually move away from the correct direction to target 113.

Diagram 120 depicts the club head conditions for a push slice golf shot. In this case, club head path 122 is now parallel to the direction to target 123. However, club head face perpendicular line 121 is not parallel to the direction to target 123. The club head face starts the ball off in the wrong direction. In addition, the lack of alignment between club head face perpendicular line 121 and club head path 122 imparts a spin on the golf ball. As golf ball path 124 shows, this causes the golf ball to immediately move away from the correct direction to target 123 and then move even further in the wrong direction.

Diagram 130 depicts the club head conditions for a straight golf shot. In this case, club head path 132 is parallel to the direction to target 133, and club head face perpendicular line 131 is also parallel to the direction to target 133. The club head face perpendicular line 131 starts the ball off in the right direction, and there is no lack of alignment between club head face perpendicular line 131 and club head path 132 to impart an incorrect spin on the golf ball. As golf ball path 134 shows, this causes the golf ball to move in the correct direction to target 133.

The diagrams of FIG. 1 show how important the direction of a club head face and a club head path at impact are to the flight of a golf ball. As a result, every golfer should understand how to control these two aspects of their golf swing. However, controlling the club head face and the club head path at impact requires an understanding of how the club head face and the club head path are behaving in the downswing before impact. Currently, there are no inexpensive devices that can be used to show a golfer the direction of the club head face and the club head path in the downswing before impact. Such immediate feedback would allow a golfer to take the appropriate action to correct their swing. For example, an average golfer can learn to more consistently hit a straight golf shot using such information. Or, a more advanced golfer can learn to deliberately hit a slice or a hook from such information.

In various embodiments, one or more sensors attached to a golf club head are used to determine the direction of a club head face and a club head path in the downswing before impact, and this information is transmitted to a wireless device using a wireless transceiver also attached to the golf club. This golf training apparatus can provide immediate feedback after each swing.

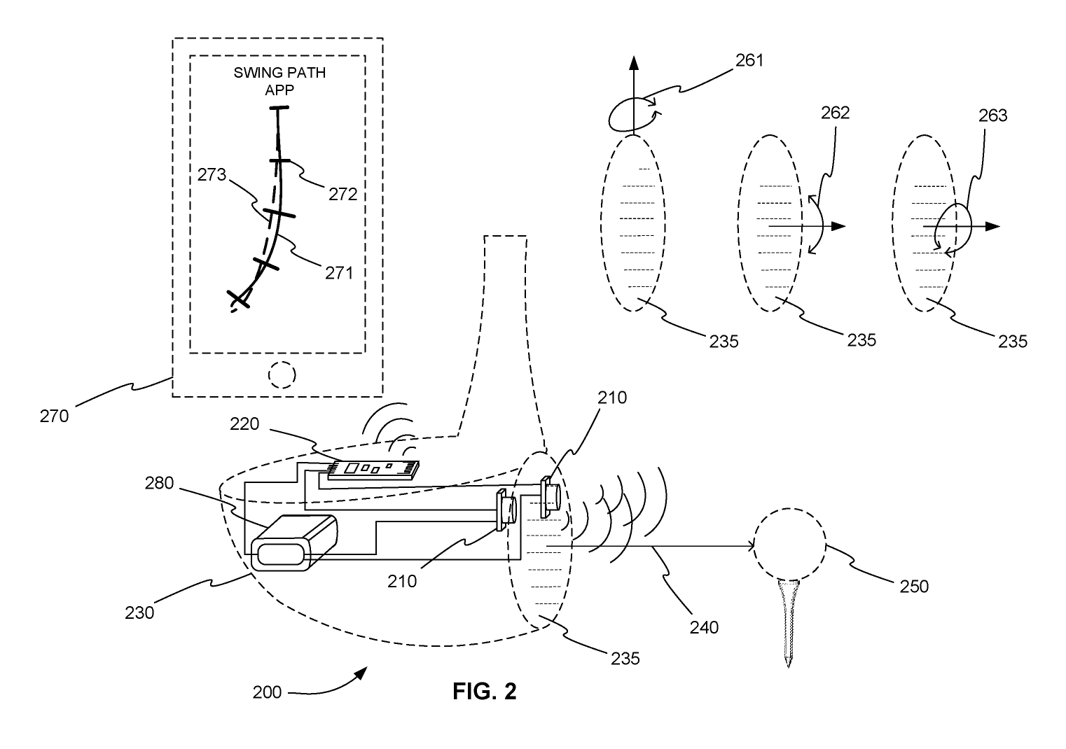

FIG. 2 is an exemplary diagram 200 of a golf swing training apparatus for viewing the location and orientation of a golf club head face relative to a golf ball before the golf club head face strikes the golf ball during the downswing of a golf club swing, in accordance with various embodiments. The golf swing training apparatus includes one or more sensors 210, wireless transceiver 220, and battery 280.

One or more sensors 210 are physically attached to head 230 of a golf club. In addition to head 230, the golf club includes a shaft (not shown) and a grip (not shown) on the shaft, for example. Head 230 includes face 235.

One or more sensors 210 detect a position 240 of face 235 of head 230 relative to golf ball 250 at a plurality of locations before face 235 strikes golf ball 250 during a downswing of a swing of the golf club. Position 240 is a vector, for example. Position 240, therefore, includes a length and three-dimensional direction.

One or more sensors 210 also detect a value for one or more of yaw 261, pitch 262, and roll 263 of face 235 relative to golf ball 250 at a plurality of locations before face 235 strikes golf ball 250 during a downswing of a swing of the golf club. A value for one or more of yaw 261, pitch 262, and roll 263 of face 235 can be an angle relative to a three-dimensional coordinate system, for example.

In a preferred embodiment, yaw 261 of face 235 is detected at a plurality of locations before face 235 strikes golf ball 250. As shown in FIG. 1, the yaw of the face of a golf club head can have a significant effect on the flight of a golf ball. In other embodiments, a value for the pitch 262 and/or roll 263 of face 235 of FIG. 2 can also be detected at a plurality of locations.

One or more sensors 210 can include any sensor capable of detecting the three-dimensional position of face 235 relative to golf ball 250 at a plurality of locations. For example, a sensor of one or more sensors 210 can be, but is not limited to, an optical sensor, a radar sensor, a radio frequency transceiver, an ultrasonic sensor, a camera, an accelerometer, a gyroscope, or an inertial measurement unit (IMU). An IMU includes both an accelerometer and a gyroscope, for example.

In a preferred embodiment, one or more sensors 210 include two or more ultrasonic sensors and an IMU sensor. The two or more ultrasonic sensors detect a position 240 of face 235 of head 230 relative to golf ball 250 at a plurality of locations. The IMU sensor detects a value for one or more of yaw 261, pitch 262, and roll 263 of face 235 relative to golf ball 250 at a plurality of locations. Low cost exemplary ultrasonic sensors can include, but are not limited to, HC-SR04 sensors and MaxSonar sensors. Low cost IMU sensors can include, but are not limited to, MPU 6050 and MPU 9150.

Wireless transceiver 220 is physically attached to the golf club. In FIG. 2, wireless transceiver 220 is attached to head 230. Wireless transceiver 220 receives a detected position 240 and a detected value for one or more of yaw 261, pitch 262, and roll 263 of face 235 at the plurality of locations. Wireless transceiver 220 transmits the detected position 240 and the detected value for one or more of yaw 261, pitch 262, and roll 263 of face 235 at the plurality of locations to an external wireless device 270.

Wireless transceiver 220 can be any type of wireless transceiver capable of transmitting and receiving wireless signals to and from an external wireless device. Wireless transceiver 220 can be, for example, a radio frequency (RF) device, such a Bluetooth or WiFi device, or an optical device such as an infrared transceiver. In a preferred embodiment, wireless transceiver 220 is an HC-05 serial Bluetooth transceiver.

External wireless device 270 displays the detected position 240 and the detected value for one or more of yaw 261, pitch 262, and roll 263 of face 235 at the plurality of locations to provide visual feedback on the swing to a user of the golf club. For example, external wireless device 270 displays the detected position 240 at the plurality of locations as actual path 271. External wireless device 270 displays values for yaw 261 of face 235 as lines 272 along path 271, for example. External wireless device 270 also displays correct path 273, for example. Correct path 273 is the path that should be used to hit golf ball 250 straight to the target, for example.

External wireless device 270 can be any external wireless device capable of transmitting and receiving wireless signals to and from a wireless transceiver. External wireless device 270 can be, but is not limited to, a smartphone, a tablet computer, a laptop computer, or a desktop computer. External wireless device 270 can also be a computer system of golf range, for example.

Battery 280 is physically attached to the golf club. In FIG. 2, battery 280 is attached to head 230. Battery 280 provides electrical power to one or more sensors 210 and wireless transceiver 220. Battery 280 can be any type of battery capable of powering one or more sensors 210 and wireless transceiver 220. In FIG. 2, battery 280 is depicted as a 9 volt battery, for example. In a preferred embodiment, battery 280 is a light weight lithium ion battery such as a watch battery.

In various embodiments, one or more sensors 210, wireless transceiver 220, and a space for battery 280 are manufactured as part of head 230 of a golf club. For example, one or more sensors 210, wireless transceiver 220, and their connections to each other and to battery 280 are manufactured by an original equipment manufacturer (OEM) and are then used in another company's golf club. Alternatively, for example, one or more sensors 210, wireless transceiver 220, and their connections to each other and to battery 280 are manufactured as part of the end product.

In various embodiments, the golf training apparatus of FIG. 2 can further include a microcontroller (not shown) and one or more aerodynamic control surfaces (not shown).

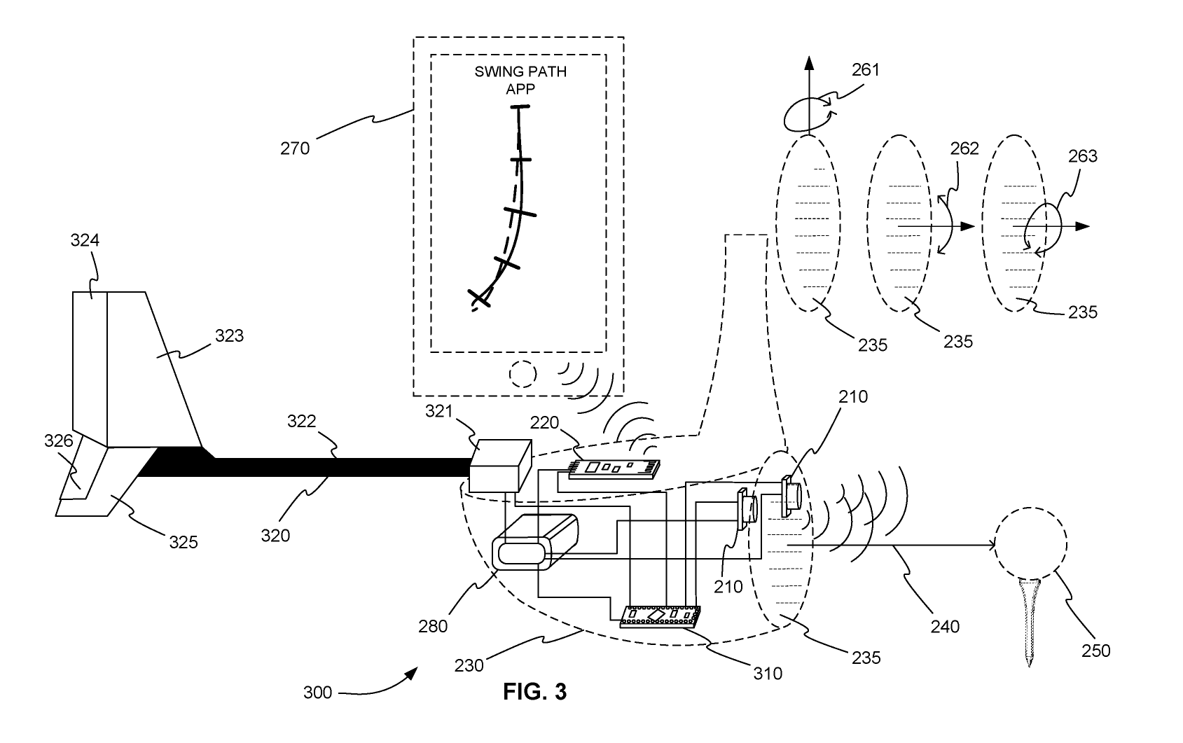

FIG. 3 is an exemplary diagram 300 of the golf swing training apparatus of FIG. 2 further including a microcontroller and one or more aerodynamic control surfaces, in accordance with various embodiments. Microcontroller 310 is physically attached to the golf club. In FIG. 3, microcontroller 310 is attached to head 230. Microcontroller 310 is in electrical communication with one or more sensors 210 and wireless transceiver 220. Microcontroller 310 is powered by battery 280. Microcontroller 310 receives a detected position and a detected value for one or more of yaw 261, pitch 262, and roll 263 of face 235 at the plurality of locations from one or more sensors 210 and electrically transmits the detected position and the detected value for one or more of yaw 261, pitch 262, and roll 263 of face 235 at the plurality of locations to wireless transceiver 220.

Microcontroller 310 can be any microcontroller capable of transmitting and receiving electrical signals, processing data, storing data, and executing instructions. Microcontroller 310 is, for example, an Arduino microcontroller.

One or more aerodynamic control surfaces 320 are physically attached to the golf club. In FIG. 3, one or more aerodynamic control surfaces 320 are attached to head 230. One or more aerodynamic control surfaces 320 are in electrical communication with microcontroller 310. One or more aerodynamic control surfaces 320 are powered by battery 280. One or more aerodynamic control surfaces can aerodynamically change one or more of yaw 261, pitch 262, and roll 263 of face 235 in response to one or more electrical inputs.

One or more aerodynamic control surfaces 320 can include any type of aerodynamic control surfaces that are capable of changing one or more of yaw 261, pitch 262, and roll 263 of face 235 in response to one or more electrical inputs. In FIG. 3, for example, one or more aerodynamic control surfaces 320 includes one or more servo motors 321, hollow boom 322, vertical stabilizer 323, rudder 324, horizontal stabilizer 325, and elevator 326. Hollow boom 322 is made of carbon fiber, for example. One servo motor (not shown) of one or more servo motors 321 activates rudder 324 through a first push rod (not shown) in hollow boom 322 to change yaw 261 of face 235 in response to one electrical input, for example. Another servo motor (not shown) of one or more servo motors 321 activates elevator 326 through a second push rod (not shown) in hollow boom 322 to change pitch 263 of face 235 in response to another electrical input, for example. Ailerons (not shown) could similarly be used to change roll 262 of face 235 in response to yet another electrical input, for example.

Microcontroller 310 receives a detected position 240 and a detected value for one or more of yaw 261, pitch 262, and roll 263 of face 235 at one or more locations of the plurality of locations from one or more sensors 210. Microcontroller 310 calculates a corrected path for face 235 from the received detected position 240 and a detected value for one or more of yaw 261, pitch 262, and roll 263 of face 235 at the one or more locations of the plurality of locations. Microcontroller 310 calculates corrective electrical inputs for the one or more electrical inputs of one or more aerodynamic control surfaces 320 to make face 235 follow the corrected path. Microcontroller 310 applies the corrective electrical inputs to the one or more electrical inputs to aerodynamically correct the swing of the golf club at the one or more locations of the plurality of locations and provide physical feedback through the golf club to a user of the golf club.

In various embodiments, microcontroller 310 can further receive commands from external wireless device 270 through wireless transceiver 220. Such commands can be used, for example, to calibrate one or more sensors 210 based on a known position of face 235. For example, in various embodiments, before one or more sensors 210 detect position 240 and a value for one or more of yaw 261, pitch 262, and roll 263 at the plurality of locations, wireless transceiver 220 receives a command from external wireless device 220. This command instructs microcontroller 310 to use the current position 240 of face 235 of head 230 of the golf club as a calibrated position at address with golf ball 250. At address, face 235 is right next to golf ball 250 and perpendicular (or square) with respect to a target for a straight golf shot, for example. Wireless transceiver 220 transmits the command to microcontroller 310.

In response to the command, microcontroller 310 receives a position 240 of face 235 of head 230 relative to golf ball 250 and a value for one or more of yaw 261, pitch 262, and roll 263 of face 235 relative to the golf ball from the one or more sensors at a current location from one or more sensors 210. Microcontroller 310 saves the position and the value for one or more of yaw 261, pitch 262, and roll 263 of face 235 at the current location in a memory of microcontroller 310. Microcontroller 310 uses the saved position and the saved value for one or more of yaw 261, pitch 262, and roll 263 of face 235 at the current location to correct subsequent detected positions of face 235 relative to golf ball 250 and subsequent detected values for one or more of yaw 261, pitch 262, and roll 263 of face 235 relative to golf ball 235 that are received from one or more sensors 210.

In various embodiments, microcontroller 310 and one or more aerodynamic control surfaces 320 are manufactured as part of head 230 of a golf club along with one or more sensors 210, wireless transceiver 220, and a space for battery 280. For example, microcontroller 310, one or more aerodynamic control surfaces 320, one or more sensors 210, wireless transceiver 220, and their connections to each other and to battery 280 are manufactured by an original equipment manufacturer (OEM) and are then used in another company's golf club. Alternatively, for example, microcontroller 310, one or more aerodynamic control surfaces 320, one or more sensors 210, wireless transceiver 220, and their connections to each other and to battery 280 are manufactured as part of the end product.

In FIGS. 2 and 3, microcontroller 310, one or more aerodynamic control surfaces 320, one or more sensors 210, wireless transceiver 220, battery 280, and their connections to each other are shown as being attached to the surface of head 230 of the golf club or attached inside of head 230 of the golf club. In an alternative embodiment, microcontroller 310, one or more aerodynamic control surfaces 320, one or more sensors 210, wireless transceiver 220, battery 280, and their connections to each other are attached to head 230 of the golf club through a removable golf club head attachment device (not shown in FIGS. 2 and 3) that is, in turn, physically attached to head 230 of the golf club.

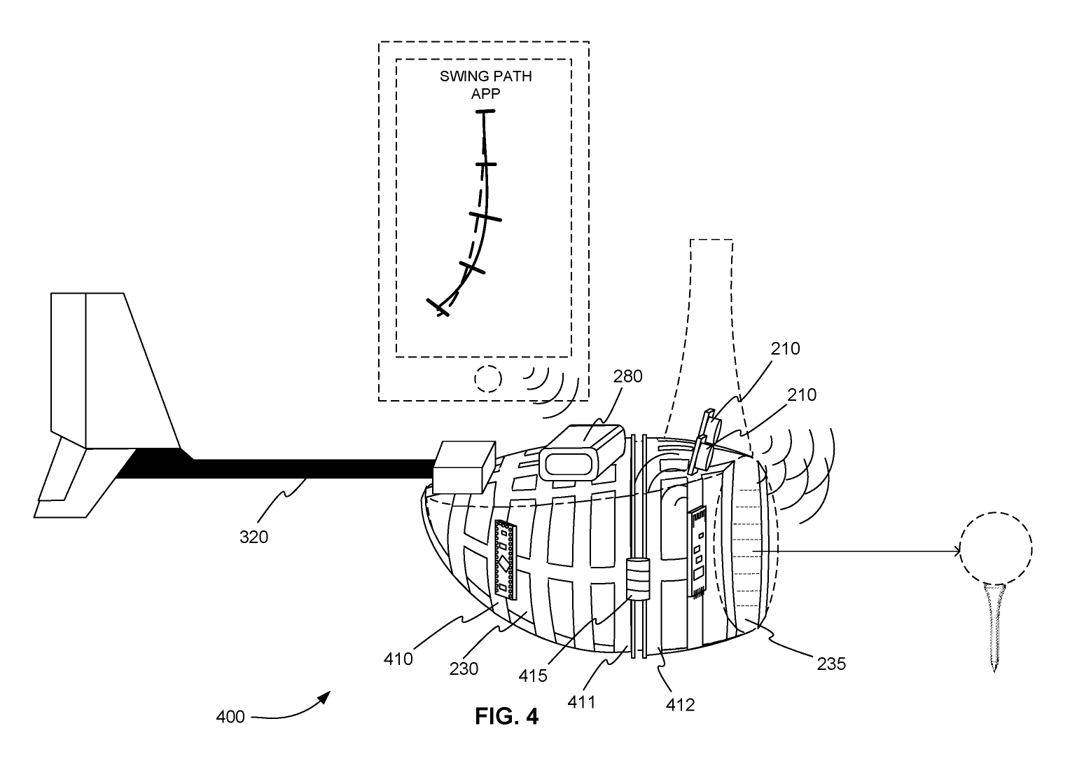

FIG. 4 is an exemplary diagram 400 of a golf swing training apparatus for viewing the location and orientation of a golf club head face relative to a golf ball before the golf club head face strikes the golf ball during the downswing of a golf club swing that includes a removable golf club head attachment device, in accordance with various embodiments. Removable golf club head attachment device 410 is physically attached to head 230 of the golf club. Removable golf club head attachment device 410 does not obscure the majority of face 235 of head 230 of the golf club. As a result, the golf club can be used to hit golf balls with removable golf club head attachment device 410 attached to head 230.

In various embodiments, removable golf club head attachment device 410 includes two sections: section 411 and section 412. Section 411 and section 412 are connected using hinge 415, for example. Hinge 415 allows removable golf club head attachment device 410 to easily be added to head 230 or removed from head 230. Opposite hinge 415, removable golf club head attachment device 410 can include a latch (not shown) to secure removable golf club head attachment device 410 to head 230 when the golf training apparatus is in use.

One or more sensors 210, wireless transceiver 220, and battery 280 are physically attached to removable golf club head attachment device 410. One or more sensors 210, wireless transceiver 220, and battery 280 are, therefore, physically attached to the golf club through the removable golf club head attachment device 410. In various embodiments, microcontroller 310 and one or more aerodynamic control surfaces 320 are also physically attached to removable golf club head attachment device 410.

Removable golf club head attachment device 410 can be made of any material capable of securely holding one or more sensors 210, wireless transceiver 220, microcontroller 310, one or more aerodynamic control surfaces 320 and battery 280. In a preferred embodiment, removable golf club head attachment device 410 is made of a non-conducting material so that one or more sensors 210, wireless transceiver 220, microcontroller 310, one or more aerodynamic control surfaces 320 and battery 280 can be attached to it without additional insulating material.

In various embodiments, head 320 is three dimensionally (3D) scanned. Removable golf club head attachment device 410 is 3D printed from the 3D scan. 3D scanning and printing allows a removable golf club head attachment device 410 to be created for any head 230 of any golf club.

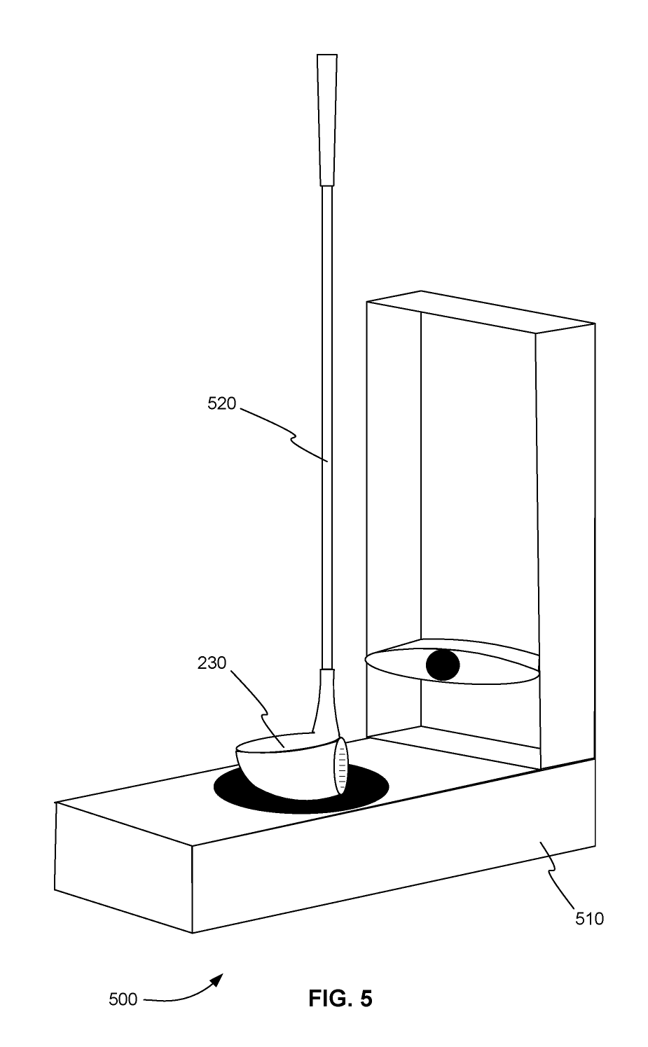

FIG. 5 is an exemplary diagram 500 of a head of a golf club being three dimensionally (3D) scanned by a 3D scanner, in accordance with various embodiments. 3D scanner 510, for example, scans head 230 of golf club 520. 3D scanner 510 produces, for example, a point cloud file, such as a stereolithography (STL) file.

In various embodiments, the STL file of head 230 of golf club 520 is then imported into a 3D solid modeling program. The 3D solid modeling program is used to create removable golf club head attachment device 410 of FIG. 4, for example. The 3D solid modeling program exports an STL file of removable golf club head attachment device 410. The STL file of removable golf club head attachment device 410 is then provided to a 3D printer.

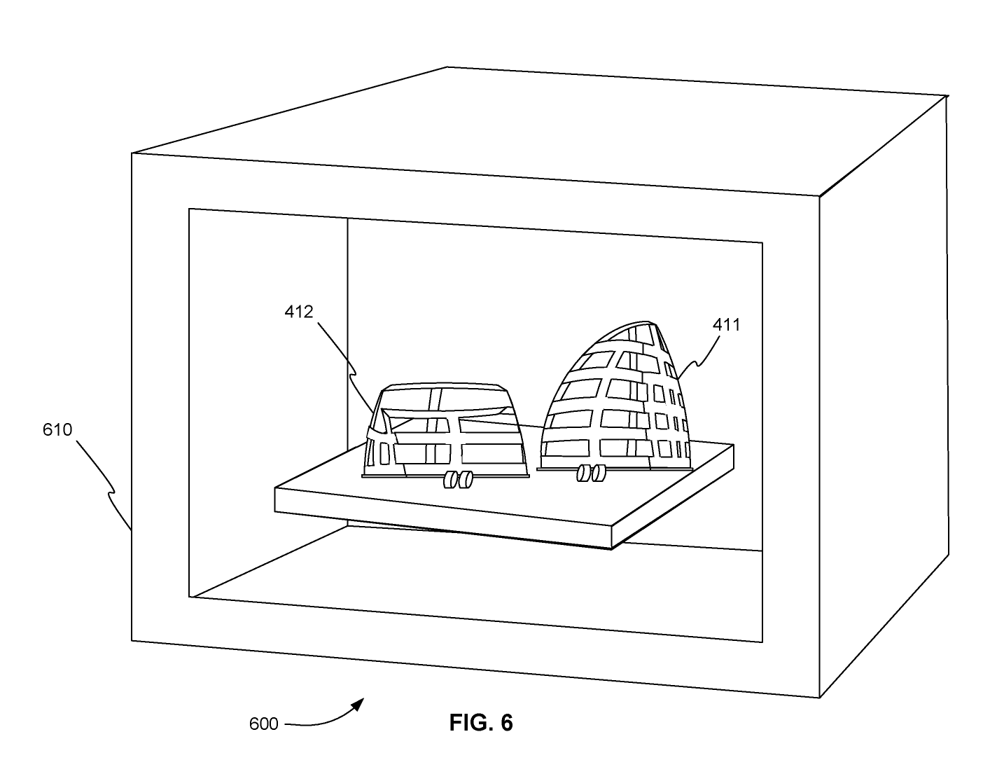

FIG. 6 is an exemplary diagram 600 of a removable golf club head attachment device being printed by a 3D printer, in accordance with various embodiments. 3D printer 610 3D prints the removable golf club head attachment device, for example, in two sections: section 411 and section 412.

In various embodiments, the golf swing training apparatus further includes a golf ball locating mat that is positioned with respect to the golf ball and a target of the golf ball so that detecting the golf ball locating mat provides a position of the golf ball with respect to the golf ball locating mat and a position of the golf ball with respect to the target. Returning to FIG. 2, one or more sensors 210 detect a position 240 of a face 235 of head 230 relative to golf ball 250 and a value for one or more of yaw 261, pitch 262, and roll 263 of face 235 relative to golf ball 250 at the plurality of locations by detecting a position of face 235 relative to a golf ball locating mat (not shown) and a value for one or more of yaw 261, pitch 262, and roll 263 of face 235 relative to the golf ball locating mat at the plurality of locations.

In various embodiments, the golf ball locating mat includes one or more mat sensors that transmit signals from one or more locations of the golf ball locating mat. One or more sensors 210 detect the transmissions from the one or more locations to determine a position and orientation of the golf ball locating mat.

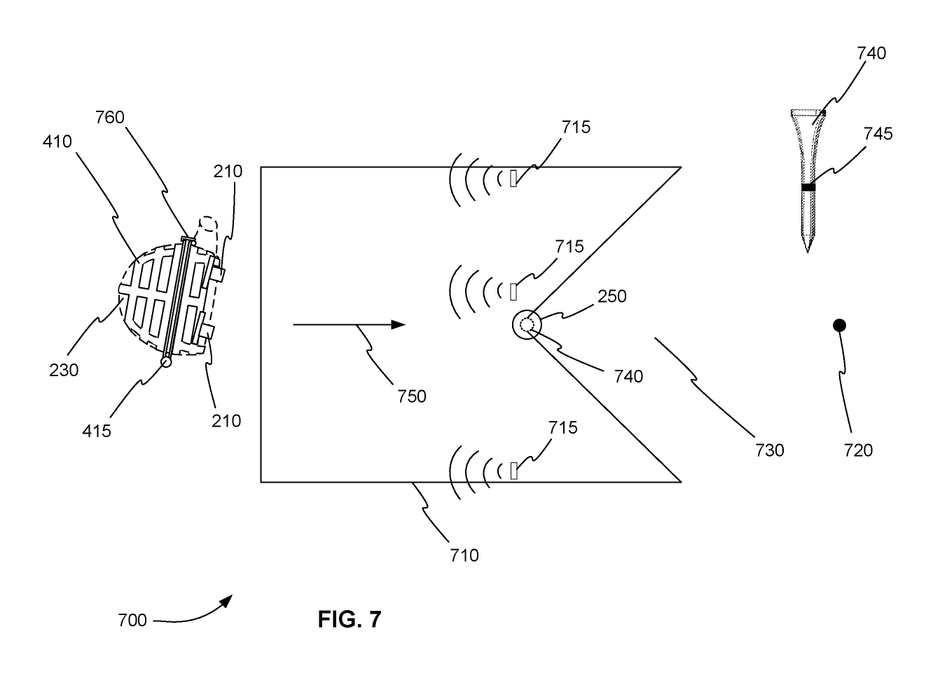

FIG. 7 is an exemplary diagram 700 showing a golf ball locating mat that includes one or more mat sensors that transmit signals from one or more locations from the golf ball locating mat, in accordance with various embodiments. Golf ball locating mat 710 is positioned with respect to golf ball 250 and target 720 of golf ball 250 so that detecting golf ball locating mat 710 provides a position of golf ball 250 with respect to golf ball locating mat 710 and a position of golf ball 250 with respect to target 720.

In various embodiments, golf ball locating mat 710 includes groove 730. Groove 730 is used to position golf ball 250 at a known location with respect to golf ball locating mat 710. For example, golf ball 250 is teed at the center of groove 730 using tee 740. The height of golf ball 250 can also be known by including a mark 745 on tee 740 that shows how deep tee 740 should be placed in the ground.

Golf ball locating mat 710 also includes arrow 750. Arrow 750 is used to position golf ball locating mat 710 with respect to target 720. For example, golf ball locating mat 710 is positioned so that arrow 750 points to target 720.

Once golf ball locating mat 710 is positioned with respect to golf ball 250 and target 720, the location of golf ball 250 and the direction of target 720 can be determined by locating the position of golf ball locating mat 710. In other words, golf ball locating mat 710 is used to indirectly find the location of golf ball 250 and the direction of target 720.

In FIG. 7, the position of golf ball locating mat 710 is detected using one or more mat sensors 715 of golf ball locating mat 710. One or more mat sensors 715 of golf ball locating mat 710 transmit signals from one or more locations of golf ball locating mat 710. One or more sensors 210 of the golf swing training apparatus attached to head 230 of a golf club detect the transmissions from the one or more locations to determine a position and orientation of golf ball locating mat 710.

One or more mat sensors 715 can include any type of sensors compatible with one or more sensors 210. For example, one or more mat sensors 715 and one or more sensors 210 can include ultrasonic transceivers and radio frequency transceivers. A radio frequency transceiver 210 of the golf swing training apparatus can receive a radio frequency transmission from a mat radio frequency transceiver 715 specifying that a specific mat ultrasonic transceiver has sent an ultrasonic transmission. From the radio frequency transmission, the golf swing training apparatus knows the location of the ultrasonic transmission on golf ball locating mat 710. From the ultrasonic transmission, the golf swing training apparatus can determine the distance to the location of the ultrasonic transmission on golf ball locating mat 710.

In FIG. 7, one or more sensors 210 are attached to head 230 through removable golf club head attachment device 410. Golf club head attachment device 410 includes hinge 415 and latch 760, for example. Golf club head attachment device 410 is secured around head 230 using hinge 415 and latch 760.

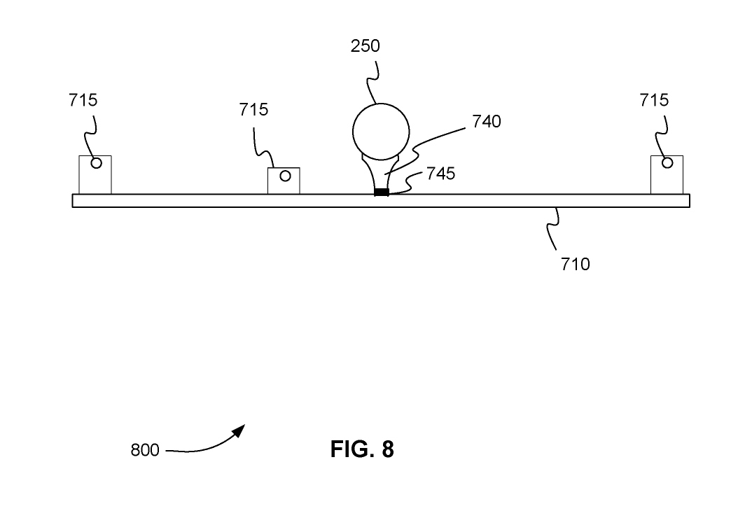

FIG. 8 is a side view 800 of the golf ball locating mat of FIG. 7, in accordance with various embodiments. In view 800, golf ball locating mat 710 is positioned with respect to golf ball 250 so that detecting golf ball locating mat 710 provides a position of golf ball 250. The height of golf ball 250 is also known from mark 745 on tee 740, for example. Mark 745 shows how deep tee 740 should be placed in the ground. Golf ball locating mat 710 includes one or more mat sensors 715. The position of golf ball locating mat 710 is detected using one or more mat sensors 715 of golf ball locating mat 710.

In an alternative and preferred embodiment, a passive golf ball locating mat (not shown) is used to provide a position of the golf ball and the target. The passive golf ball locating mat includes one or more orientation surfaces and the one or more sensors detect the one or more orientation surfaces to determine a position and orientation of the golf ball locating mat.

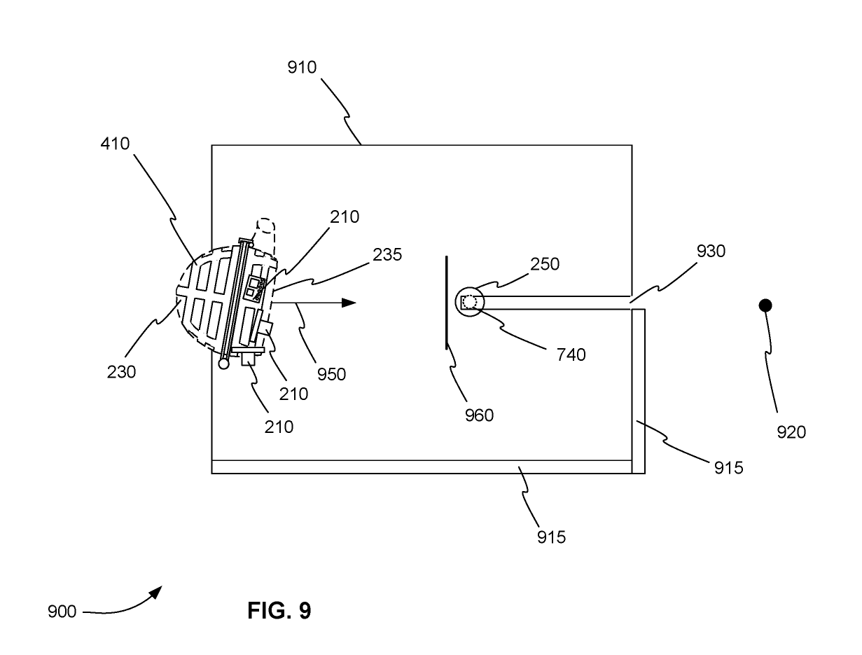

FIG. 9 is an exemplary diagram 900 showing a passive golf ball locating mat that includes one or more orientation surfaces that are detected by one or more sensors of the golf swing training apparatus to determine a position and orientation of the golf ball locating mat, in accordance with various embodiments. Passive golf ball locating mat 910 is positioned with respect to golf ball 250 and target 920 of golf ball 250 so that detecting passive golf ball locating mat 910 provides a position of golf ball 250 with respect to passive golf ball locating mat 910 and a position of golf ball 250 with respect to target 920.

In various embodiments, passive golf ball locating mat 910 includes groove 930. Groove 930 is used to position golf ball 250 at a known location with respect to passive golf ball locating mat 910. For example, golf ball 250 is teed at the end of groove 930 using tee 740. The height of golf ball 250 can also be known by including a mark on tee 740 that shows how deep tee 740 should be placed in the ground.

Passive golf ball locating mat 910 also includes arrow 950. Arrow 950 is used to position passive golf ball locating mat 910 with respect to target 920. For example, passive golf ball locating mat 910 is positioned so that arrow 950 points to target 920.

Once passive golf ball locating mat 910 is positioned with respect to golf ball 250 and target 920, the location of golf ball 250 and the direction of target 920 can be determined by locating the position of passive golf ball locating mat 910. In other words, passive golf ball locating mat 910 is used to indirectly find the location of golf ball 250 and the direction of target 920.

In FIG. 9, the position of passive golf ball locating mat 910 is detected using one or more orientation surfaces 915 of golf ball locating mat 915. One or more orientation surfaces 915 can include, for example, walls that are perpendicular to passive golf ball locating mat 910. In FIG. 9, a front wall and a side wall are depicted. One or more orientation surfaces 915 can also include the floor of passive golf ball locating mat 910.

One or more sensors 210 of head 230 of a golf club detect one or more orientation surfaces 915 to determine the position of passive golf ball locating mat 910 with respect to head 230. For example, one sensor of one or more sensors 210 detects the front wall of one or more orientation surfaces 915. Another sensor of one or more sensors 210 detects the side wall of one or more orientation surfaces 915. A third sensor (not shown) can point towards the ground from head 230 and can detect the floor of passive golf ball locating mat 910. In this way, the 3D location of head 230 with respect to passive golf ball locating mat 910 is determined. Further, one or more sensors 210 can include an IMU that determines the yaw, pitch, and roll of face 235 of head 230. In FIG. 9, one or more sensors 210 are attached to head 230 through removable golf club head attachment device 410, for example.

In various embodiments, passive golf ball locating mat 910 further includes line 960. Line 960 is a known distance from groove 930. Line 960 is used by a golfer to calibrate one or more sensors 210 of the golf swing training apparatus. For example, face 235 of head 230 of the golf club can be placed parallel to line 960 during calibration. From the known distance of line 960 to golf ball 250, one or more sensors 210 of head 230 can be calibrated.

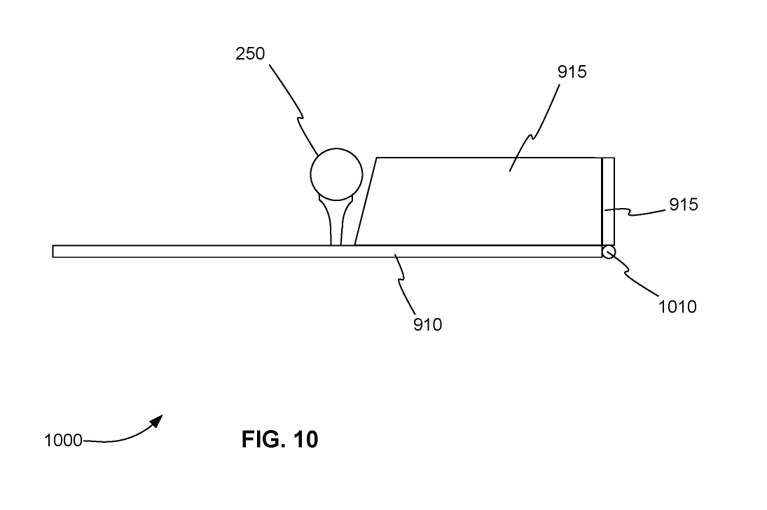

FIG. 10 is a side view 1000 of the passive golf ball locating mat of FIG. 9, in accordance with various embodiments. In view 1000, passive golf ball locating mat 910 is positioned with respect to golf ball 250 so that detecting golf ball locating mat 910 provides a position of golf ball 250. Passive golf ball locating mat 910 includes one or more orientation surfaces 915. In view 100, one or more orientation surfaces 915 include a front wall and side wall. One or more orientation surfaces 915 can also include passive golf ball locating mat 910 (its floor) itself. In view 1000, the side wall includes hinge 1010. The front wall can also include a hinge.

In view 1010, the front and side walls of passive golf ball locating mat 910 are positioned for a right-handed golf club. By flipping passive golf ball locating mat 910 over on its other side, and turning the front and side walls to the other side using their hinges, passive golf ball locating mat 910 can be configured for a left-handed golf club. Thus, passive golf ball locating mat 910 works for both right-handed and left-handed golfers.

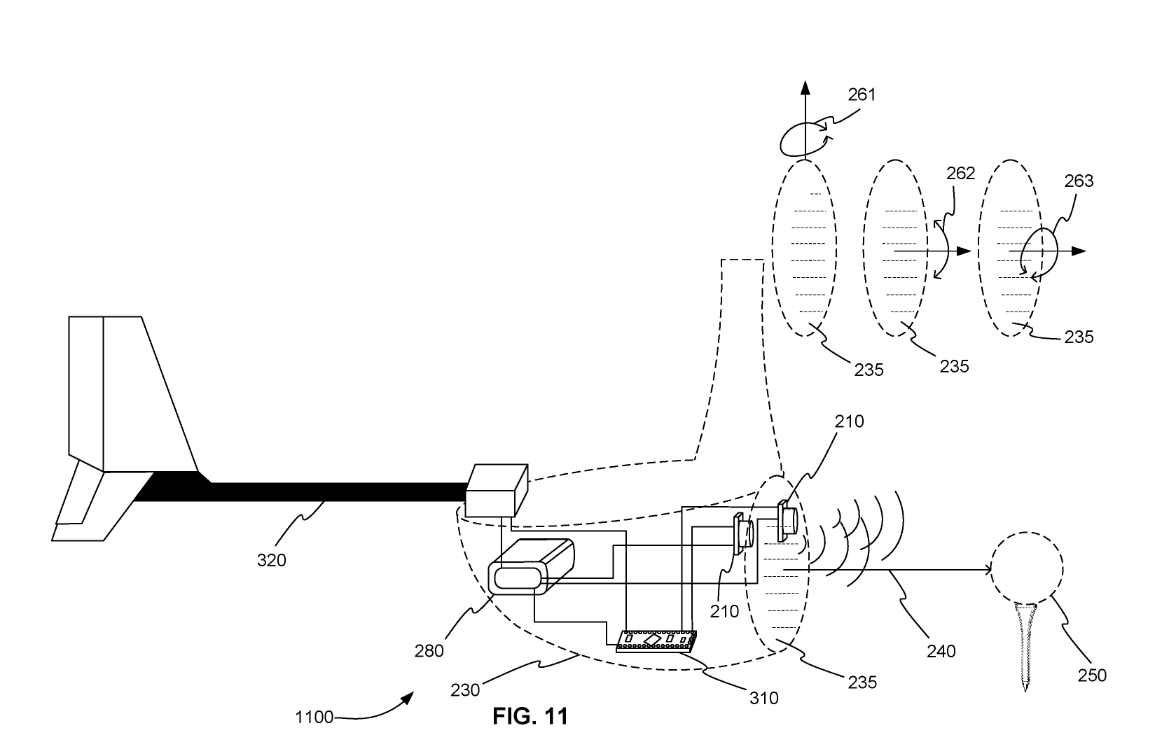

FIG. 11 is an exemplary diagram 1100 of a golf swing training apparatus for correcting the location and orientation of a golf club head face relative to a golf ball before the golf club head face strikes the golf ball during the downswing of a golf club swing, in accordance with various embodiments. The golf swing training apparatus includes one or more sensors 210, one or more aerodynamic control surfaces 320, microcontroller 310, and battery 280.

One or more sensors 210 are physically attached to head 230 of a golf club. One or more sensors 210 detect a position 240 of face 235 of head 230 relative to golf ball 250 at a plurality of locations before face 235 strikes golf ball 250 during the downswing of a swing of the golf club. One or more sensors 210 also detect a value for one or more of yaw 261, pitch 262, and roll 263 of face 235 relative to golf ball 250 at the plurality of locations.

One or more aerodynamic control surfaces 320 are physically attached to head 230. One or more aerodynamic control surfaces 320 can aerodynamically change one or more of the yaw 261, pitch 262, and roll 263 of face 235 in response to one or more electrical inputs.

Microcontroller 310 is physically attached to the golf club. Microcontroller 310 receives a detected position 240 and a detected value for one or more of the yaw 261, pitch 262, and roll 263 of face 235 at one or more locations of the plurality of locations from one or more sensors 210. Microcontroller 310 calculates a corrected path for face 235 from the received detected position 240 and a detected value for one or more of the yaw 261, pitch 262, and roll 263 of face 235 at the one or more locations of the plurality of locations. Microcontroller 310 calculates corrective electrical inputs for the one or more electrical inputs to make face 235 follow the corrected path. Finally, microcontroller 310 applies the corrective electrical inputs to the one or more electrical inputs to aerodynamically correct the swing of the golf club. This provides physical feedback through the golf club to a user of the golf club.

Battery 280 is physically attached to the golf club. Battery 280 provides electrical power to one or more sensors 210, the one or more aerodynamic control surfaces 320, and the microcontroller 310.

In various embodiments, one or more sensors 210, one or more aerodynamic control surfaces 320, and microcontroller 310 can be physically attached to head 230 through a golf club head attachment device (not shown).

In various embodiments, the golf swing training apparatus of FIG. 11 can further include a golf ball locating mat (not shown).

In various embodiments the golf swing training apparatus of FIG. 11 can further include a wireless transceiver (not shown) physically attached to the golf club. The wireless transceiver receives a detected position 240 and a detected value for one or more of the yaw 261, pitch 262, and roll 263 of face 235 at the one or more locations of the plurality of locations from the microcontroller 310. The wireless transceiver transmits the detected position 240 and the detected value for one or more of the yaw 261, pitch 262, and roll 263 of face 235 at the one or more locations of the plurality of locations to an external wireless device (not shown). The wireless transceiver transmits this information so that the detected position 240 and the detected value for one or more of the yaw 261, pitch 262, and roll 263 of face 235 at the one or more locations of the plurality of locations are displayed on the external wireless device. This display of information provides visual feedback on the swing to a user of the golf club.

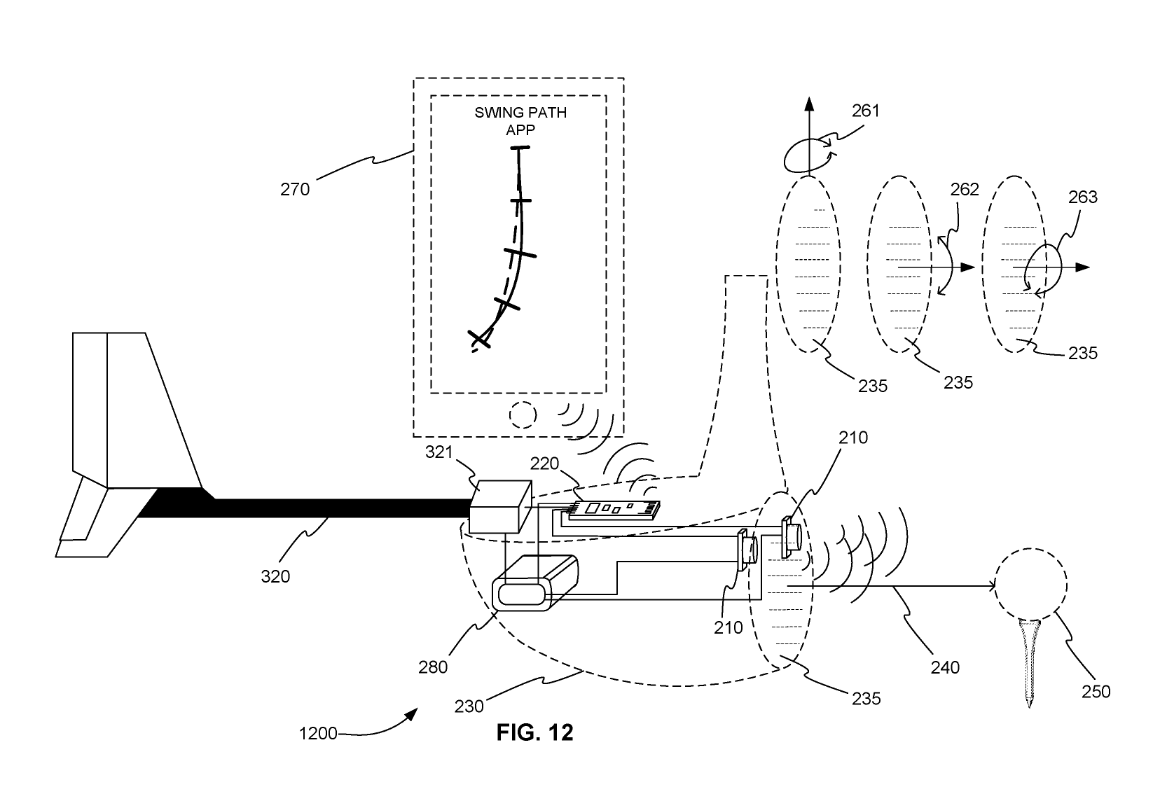

FIG. 12 is an exemplary diagram 1200 of a golf swing training apparatus for correcting the location and orientation of a golf club head face relative to a golf ball before the golf club head face strikes the golf ball during the downswing of a golf club swing where correction calculations are performed on an external wireless device, in accordance with various embodiments. The golf swing training apparatus includes one or more sensors 210, one or more aerodynamic control surfaces 320, wireless transceiver 220, and battery 280.

One or more sensors 210 are physically attached to head 320 of a golf club. One or more sensors 210 detect a position 240 of face 235 of head 230 relative to golf ball 250 at a plurality of locations before face 235 strikes golf ball 250 during the downswing of a swing of the golf club. One or more sensors 210 also detect a value for one or more of the yaw, pitch, and roll of face 235 relative to golf ball 250 at the plurality of locations.

One or more aerodynamic control surfaces 320 are physically attached to head 230. One or more aerodynamic control surfaces 320 can aerodynamically change one or more of yaw 261, pitch 262, and roll 263 of face 235 in response to one or more electrical inputs.

Wireless transceiver 220 is physically attached to the golf club. Wireless transceiver 220 receives a detected position 240 and a detected value for one or more of the yaw 261, pitch 262, and roll 263 of face 235 at one or more locations of the plurality of locations from one or more sensors 210. Wireless transceiver 220 transmits a detected position 240 and a detected value for one or more of the yaw 261, pitch 262, and roll 263 of face 235 at one or more locations of the plurality of locations to external wireless device 270.

External wireless device 270 calculates a corrected path for face 235 from the received detected position 240 and a detected value for one or more of the yaw 261, pitch 262, and roll 263 of face 235 at the one or more locations of the plurality of locations. External wireless device 270 calculates corrective electrical inputs for the one or more electrical inputs to make face 235 follow the corrected path.

Wireless transceiver 220 receives the corrective electrical inputs from the external wireless device 270. Wireless transceiver 220 applies the corrective electrical inputs to the one or more electrical inputs to aerodynamically correct the swing of the golf club. This provides physical feedback through the golf club to a user of the golf club.

Battery 280 physically attached to the golf club that provides electrical power to one or more sensors 210, the one or more aerodynamic control surfaces 320, and wireless transceiver 220.

In various embodiments, one or more sensors 210, one or more aerodynamic control surfaces 320, and wireless transceiver 220 can be physically attached to head 230 through a golf club head attachment device (not shown).

In various embodiments, the golf swing training apparatus of FIG. 12 can further include a golf ball locating mat (not shown).

Various embodiments include a method for viewing the location and orientation of a golf club head face relative to a golf ball before the golf club head face strikes the golf ball during the downswing of a golf club swing.

A first step of the method includes detecting a position of a face of a head of a golf club relative to a golf ball and a value for one or more of the yaw, pitch, and roll of the face relative to the golf ball at a plurality of locations before the face strikes the golf ball during a downswing of a swing of the golf club using one or more sensors physically attached to a head of a golf club.

A second step includes receiving a detected position and a detected value for one or more of the yaw, pitch, and roll of the face at the plurality of locations using a wireless transceiver physically attached to the golf club.

A third step includes transmitting the detected position and the detected value for one or more of the yaw, pitch, and roll of the face at the plurality of locations to an external wireless device using the wireless transceiver. This information is transmitted so that the detected position and the detected value for one or more of the yaw, pitch, and roll of the face at the plurality of locations are displayed on the external wireless device to provide visual feedback on the swing to a user of the golf club.

Various embodiments include a method for correcting the location and orientation of a golf club head face relative to a golf ball before the golf club head face strikes the golf ball during the downswing of a golf club swing.

A first step of the method includes detecting a position of a face of a head of a golf club relative to a golf ball and a value for one or more of the yaw, pitch, and roll of the face relative to the golf ball at a plurality of locations before the face strikes the golf ball during a downswing of a swing of the golf club using one or more sensors physically attached to a head of a golf club.

A second step includes receiving a detected position and a detected value for one or more of the yaw, pitch, and roll of the face at one or more locations of the plurality of locations using a microcontroller physically attached to the golf club.

A third step includes calculating a corrected path for the face from the received detected position and a detected value for one or more of the yaw, pitch, and roll of the face at the one or more locations of the plurality of locations using the microcontroller.

A fourth step includes calculating corrective electrical inputs for one or more electrical inputs of one or more aerodynamic control surfaces physically attached to the head that aerodynamically change one or more of the yaw, pitch, and roll of the face in response to the one or more electrical inputs to make the face follow the corrected path using the microcontroller.

A final step includes applying the corrective electrical inputs to the one or more electrical inputs using the microcontroller to aerodynamically correct the swing of the golf club and provide physical feedback through the golf club to a user of the golf club.

Various embodiments include a method for viewing the location and orientation of a golf club head face relative to a golf ball before the golf club head face strikes the golf ball during the downswing of a golf club swing where correction calculations are performed on an external wireless device.

A first step of the method includes detecting a position of a face of a head of a golf club relative to a golf ball and a value for one or more of the yaw, pitch, and roll of the face relative to the golf ball at a plurality of locations before the face strikes the golf ball during a downswing of a swing of the golf club using one or more sensors physically attached to a head of a golf club.

A second step includes receiving a detected position and a detected value for one or more of the yaw, pitch, and roll of the face at one or more locations of the plurality of locations using a wireless transceiver physically attached to the golf club.

A third step includes transmitting a detected position and a detected value for one or more of the yaw, pitch, and roll of the face at one or more locations of the plurality of locations to an external wireless device using the wireless transceiver. The an external wireless device calculates a corrected path for the face from the received detected position and a detected value for one or more of the yaw, pitch, and roll of the face at the one or more locations of the plurality of locations. The external wireless device also calculates corrective electrical inputs for one or more electrical inputs of one or more aerodynamic control surfaces physically attached to the head that aerodynamically change one or more of the yaw, pitch, and roll of the face in response to the one or more electrical inputs to make the face follow the corrected path.

A fourth step includes receiving the corrective electrical inputs from the external wireless device using the wireless transceiver.

A final step includes applying the corrective electrical inputs to the one or more electrical inputs using the wireless transceiver to aerodynamically correct the swing of the golf club and provide physical feedback through the golf club to a user of the golf club.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

1. A golf swing training apparatus for viewing the location and orientation of a golf club head face relative to a golf ball before the golf club head face strikes the golf ball during the downswing of a golf club swing, comprising:
one or more sensors physically attached to a head of a golf club that detect a position of a face of the head relative to a golf ball and a value for one or more of the yaw, pitch, and roll of the face relative to the golf ball at a plurality of locations before the face strikes the golf ball during a downswing of a swing of the golf club;
a wireless transceiver physically attached to the golf club that receives a detected position and a detected value for one or more of the yaw, pitch, and roll of the face at the plurality of locations and transmits the detected position and the detected value for one or more of the yaw, pitch, and roll of the face at the plurality of locations to an external wireless device so that the detected position and the detected value for one or more of the yaw, pitch, and roll of the face at the plurality of locations are displayed on the external wireless device to provide visual feedback on the swing to a user of the golf club; and
a battery physically attached to the golf club that provides electrical power to the one or more sensors and the wireless transceiver.

2. The golf swing training apparatus of claim 1, wherein the one or more sensors, the wireless transceiver, and space for the battery are manufactured as part of the head of the golf club.

3. The golf swing training apparatus of claim 1, further comprising a removable golf club head attachment device that is physically attached to the head of the golf club and that does not obscure the majority of the face of the head of the golf club, wherein the one or more sensors, the wireless transceiver, and the battery are physically attached to the removable golf club head attachment device and to the golf club through the removable golf club head attachment device.

4. The golf swing training apparatus of claim 3, wherein the removable golf club head attachment device is three dimensionally (3D) printed.

5. The golf swing training apparatus of claim 1, wherein the one or more sensors include one or more of an optical sensor, a radar sensor, a radio frequency transceiver, an ultrasonic sensor, a camera, an accelerometer, or a gyroscope.

6. The golf swing training apparatus of claim 1, further comprising a golf ball locating mat that is positioned with respect to the golf ball and a target of the golf ball so that detecting the golf ball locating mat provides a position of the golf ball with respect to the golf ball locating mat and a position of the golf ball with respect to the target.

7. The golf swing training apparatus of claim 6, wherein one or more sensors detect a position of a face of the head relative to the golf ball or a value for one or more of the yaw, pitch, and roll of the face relative to the golf ball at the plurality of locations by detecting a position of a face of the head relative to the golf ball locating mat and a value for one or more of the yaw, pitch, and roll of the face relative to the golf ball locating mat at the plurality of locations.

8. The golf swing training apparatus of claim 7, wherein the golf ball locating mat includes one or more mat sensors that transmit signals from one or more locations of the golf ball locating mat and the one or more sensors detect the transmitted signals from the one or more locations to determine a position and orientation of the golf ball locating mat.

9. The golf swing training apparatus of claim 7, wherein the golf ball locating mat includes one or more orientation surfaces and the one or more sensors detect the one or more orientation surfaces to determine a position and orientation of the golf ball locating mat.

10. The golf swing training apparatus of claim 1, further comprising a microcontroller physically attached to the golf club, in electrical communication with the one or more sensors and the wireless transceiver, and powered by the battery that electrically receives a detected position and a detected value for one or more of the yaw, pitch, and roll of the face at the plurality of locations from the one or more sensors and electrically transmits the detected position and the detected value for one or more of the yaw, pitch, and roll of the face at the plurality of locations to the wireless transceiver.

11. The golf swing training apparatus of claim 10, further comprising
one or more aerodynamic control surfaces physically attached to the head, in electrical communication with the microcontroller, and powered by the battery that aerodynamically change one or more of the yaw, pitch, and roll of the face in response to one or more electrical inputs,
wherein the microcontroller
receives a detected position and a detected value for one or more of the yaw, pitch, and roll of the face at one or more locations of the plurality of locations from the one or more sensors,
calculates a corrected path for the face from the received detected position and a detected value for one or more of the yaw, pitch, and roll of the face at the one or more locations of the plurality of locations,
calculates corrective electrical inputs for the one or more electrical inputs to make the face follow the corrected path at the one or more locations of the plurality of locations, and
applies the corrective electrical inputs to the one or more electrical inputs to aerodynamically correct the swing of the golf club at the one or more locations of the plurality of locations and provide physical feedback through the golf club to a user of the golf club.

12. The golf swing training apparatus of claim 10, wherein before the one or more sensors detect a position and a value for one or more of the yaw, pitch, and roll at the plurality of locations,
the wireless transceiver receives a command from the external wireless device to use the current position of the face of the head of the golf club as a calibrated position at address with the golf ball and transmits the command to the microcontroller, and
the microcontroller receives a position of a face of the head relative to a golf ball and a value for one or more of the yaw, pitch, and roll of the face relative to the golf ball from the one or more sensors at a current location from the one or more sensors, saves the position and the value for one or more of the yaw, pitch, and roll of the face at the current location in a memory of the microcontroller, and uses the saved position and the saved value for one or more of the yaw, pitch, and roll of the face at the current location to correct subsequent detected positions of the face relative to the golf ball and subsequent detected values for one or more of the yaw, pitch, and roll of the face relative to the golf ball that are received from the one or more sensors.

13. A golf swing training apparatus for correcting the location and orientation of a golf club head face relative to a golf ball before the golf club head face strikes the golf ball during the downswing of a golf club swing, comprising:
one or more sensors physically attached to a head of a golf club that detect a position of a face of the head relative to a golf ball and a value for one or more of the yaw, pitch, and roll of the face relative to the golf ball at a plurality of locations before the face strikes the golf ball during the downswing of a swing of the golf club;
one or more aerodynamic control surfaces physically attached to the head that aerodynamically change one or more of the yaw, pitch, and roll of the face in response to one or more electrical inputs;
a microcontroller physically attached to the golf club that
receives a detected position and a detected value for one or more of the yaw, pitch, and roll of the face at one or more locations of the plurality of locations from the one or more sensors,
calculates a corrected path for the face from the received detected position and a detected value for one or more of the yaw, pitch, and roll of the face at the one or more locations of the plurality of locations,
calculates corrective electrical inputs for the one or more electrical inputs to make the face follow the corrected path, and
applies the corrective electrical inputs to the one or more electrical inputs to aerodynamically correct the swing of the golf club and provide physical feedback through the golf club to a user of the golf club; and
a battery physically attached to the golf club that provides electrical power to the one or more sensors, the one or more aerodynamic control surfaces, and the microcontroller.

14. The golf swing training apparatus of claim 13, further comprising a wireless transceiver physically attached to the golf club that that receives a detected position and a detected value for one or more of the yaw, pitch, and roll of the face at the one or more locations of the plurality of locations from the microcontroller and transmits the detected position and the detected value for one or more of the yaw, pitch, and roll of the face at the one or more locations of the plurality of locations to an external wireless device so that the detected position and the detected value for one or more of the yaw, pitch, and roll of the face at the one or more locations of the plurality of locations are displayed on the external wireless device to provide visual feedback on the swing to a user of the golf club.

15. A golf swing training apparatus for correcting the location and orientation of a golf club head face relative to a golf ball before the golf club head face strikes the golf ball during the downswing of a golf club swing where correction calculations are performed on an external wireless device, comprising:
one or more sensors physically attached to a head of a golf club that detect a position of a face of the head relative to a golf ball and a value for one or more of the yaw, pitch, and roll of the face relative to the golf ball at a plurality of locations before the face strikes the golf ball during the downswing of a swing of the golf club;
one or more aerodynamic control surfaces physically attached to the head that aerodynamically change one or more of the yaw, pitch, and roll of the face in response to one or more electrical inputs;
a wireless transceiver physically attached to the golf club that receives a detected position and a detected value for one or more of the yaw, pitch, and roll of the face at one or more locations of the plurality of locations from the one or more sensors,
transmits a detected position and a detected value for one or more of the yaw, pitch, and roll of the face at one or more locations of the plurality of locations to an external wireless device that calculates a corrected path for the face from the received detected position and a detected value for one or more of the yaw, pitch, and roll of the face at the one or more locations of the plurality of locations and that calculates corrective electrical inputs for the one or more electrical inputs to make the face follow the corrected path,
receives the corrective electrical inputs from the external wireless device, and
applies the corrective electrical inputs to the one or more electrical inputs to aerodynamically correct the swing of the golf club and provide physical feedback through the golf club to a user of the golf club; and
a battery physically attached to the golf club that provides electrical power to the one or more sensors, the one or more aerodynamic control surfaces, and the wireless transceiver.

16-18. (canceled)
